(19) United States
(12) Patent Application Publication
(10) Pub. No.: US 2005/0233708 A1
(43) Pub. Date: Oct. 20, 2005

(54) Portable terminal with touch key

(75) Inventors: Jung-Hyeok Im, Seongnam-si (KR); Jong-Seong Lee, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/020,840

(22) Filed: Dec. 23, 2004

(30) Foreign Application Priority Data
Apr. 14, 2004 (KR) 2004-0025721

(51) Int. Cl. H04M 1/00; H04B 1/38

(52) U.S. Cl. 455/90.3

(57) ABSTRACT

Disclosed is a portable terminal including touch keys, including a main housing, a sliding housing, which is opened/closed with respect to the main housing, a plurality of first touch keys aligned on an upper surface of the main housing to allow a user to input data into the portable terminal with a touch action, and first parts for dividing touch regions of the first touch keys.

### PRIORITY

This application claims priority to an application entitled “PORTABLE TERMINAL WITH TOUCH KEY” filed with the Korean Intellectual Property Office on Apr. 14, 2004 and assigned Serial No. 2004-25721, the contents of which are hereby incorporated by reference.

### BACKGROUND OF THE INVENTION

1. Field of the Invention

The present invention relates to portable communication apparatuses, such as cellular phones, PDAs (personal digital assistants), HHPs (hand held phones), and digital communication apparatuses, and more particularly to a portable terminal including touch keys allowing a user to easily input data into the portable terminal using the touch keys through a new concept of simple touch motions.

2. Description of the Related Art

In general, a “portable communication apparatus” refers to an electronic apparatus allowing a user to perform wireless communication with a desired partner while carrying the portable communication apparatus. In consideration of portability, designs of such portable communication apparatuses tend to be compact, slim, and light, and also have multimedia availability, having a wider variety of functions. In particular, future portable communication apparatuses are gradually expected to incorporate greater multi-functionality and multi-purpose utilization, as well as being even more compact and lighter, and also will likely be modified to be suitable for various multimedia environments or Internet environments. Additionally, such portable communication apparatuses are now commonly used by many people throughout the world, and are recognized by many as an indispensable part of everyday life.

Conventional portable communication apparatuses may be classified into various types according to external appearances thereof. For example, the conventional portable communication apparatuses are divided into bar-type portable communication apparatuses, flip-type portable communication apparatuses, and folder-type portable communication apparatuses according to their external appearances. The bar-type portable communication apparatus has a single housing shaped like a bar. The flip-type portable communication apparatus has a flip which is rotatively mounted to a bar-shaped housing by a hinge unit. The folder-type portable communication apparatus has a folder coupled to a single bar-shaped housing by a hinge unit in such a manner that the folder can be rotated in order to be folded to or unfolded from the housing.

Further, portable communication apparatuses may be classified into neck wearable type communication apparatuses and wrist wearable type communication apparatuses according to the position thereof or the way in which a user puts on the communication apparatus. The neck wearable type communication apparatus is one which a user wears around the neck by using a string, while the wrist wearable type communication apparatus is one which a user wears around the wrist.

Additionally, portable communication apparatuses may be further classified into rotation-type communication apparatuses and sliding-type communication apparatuses according to ways of opening and closing the communication apparatuses. In the rotation-type portable communication apparatus, two housings are coupled to each other in such a manner that one housing rotates to be opened or closed relative to the other while facing each other. In the sliding-type portable communication apparatus, two housings are coupled to each other in such a manner that one housing slides to be opened or closed relative to the other. These variously classified portable communication apparatuses can be easily understood by those skilled in the art.

Meanwhile, conventional portable communication apparatuses now also tend to have a function of transmitting data at a high speed in addition to their basic function of performing voice communication. In other words, according to the increase of demand by consumers, portable communication apparatuses now tend to provide a service using a wireless communication technology capable of transmitting data at a high speed.

Recent portable communication apparatuses tend to be equipped with a camera lens which enables them to transmit an image signal. That is, current conventional portable communication apparatuses may have an imbedded or external camera lens, so that a user can perform image communication with a desired partner or take a photograph of a desired subject by a photographing means.

The above-mentioned various types of portable terminals essentially include antennas, data input/output apparatuses, and transmitting/receiving units. The data input apparatus includes generally a keypad or a touchpad allowing a user to input data by pressing keys of the keypad or the touchpad with their fingers, and the data output apparatus includes a liquid crystal display.

However, according to the conventional key pad used as a data input device, it is required for a user to press the key pad with a predetermined amount of force in order to achieve data input operation, which may be inconvenient. Particularly, since the key pad known in the art essentially includes rubber members for keys and metal domes, a thickness of the key pad becomes enlarged, resulting in a limitation in designing the external appearance of the key pad.

### SUMMARY OF THE INVENTION

Accordingly, the present invention has been made to solve the above-mentioned problems occurring in the prior art, and an object of the present invention is to provide a touch key, which enables a user to easily input data.

Another object of the present invention is to provide a touch key capable of preventing a touch error by providing protrusions having predetermined shapes.

Still another object of the present invention is to provide a touch key, which can be designed with various external appearances.

Still another object of the present invention is to provide a touch key, which can be fabricated with a simple design.

Still another object of the present invention is to provide a portable terminal, which can be slidably opened and closed in an easy manner.

In order to accomplish the above objects, there is provided a portable terminal including a main housing; a sliding housing, which is opened/closed with respect to the main housing; a plurality of first touch keys aligned on an upper surface of the main housing to allow a user to input data into the portable terminal with a touch manner; and first parts for dividing touch regions of the first touch keys.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing a portable terminal having a touch key according to a preferred embodiment of the present invention;

FIG. 2 is a perspective view showing a full-open state of a sliding housing shown in FIG. 1;

FIG. 3 is a plan view of FIG. 2;

FIG. 4 is a left side view of FIG. 2; and

FIG. 5 is a partial perspective view showing a bottom surface of a portable terminal having a touch key according to a preferred embodiment of the present invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention unclear.

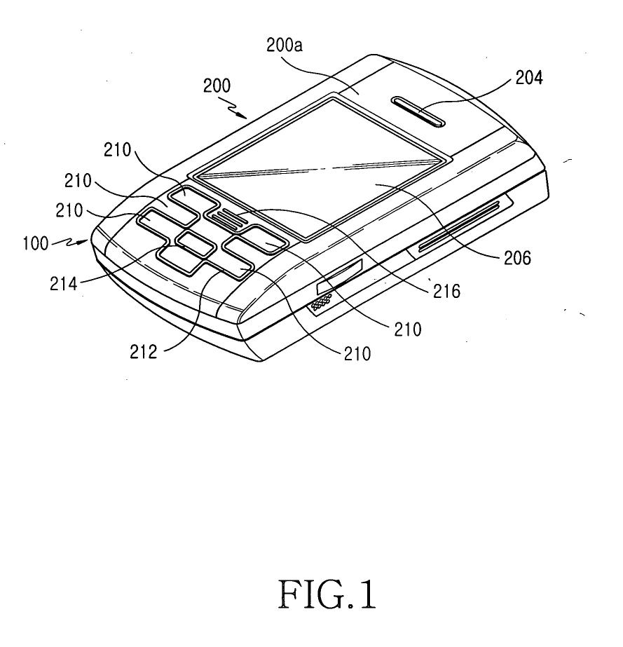

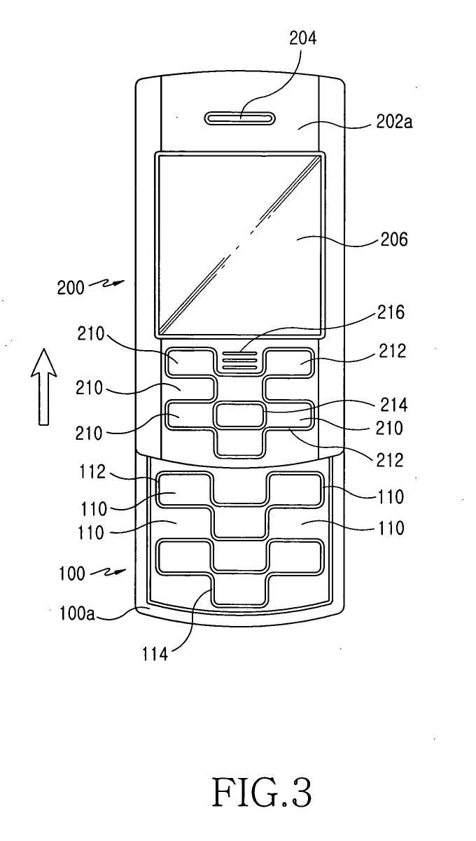

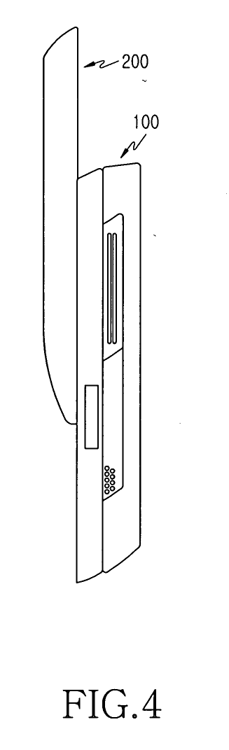

As shown in FIGS. 1 to 4, a portable terminal according to the present invention includes a plurality of first and second touch keys 110 and 210, which allow a user to easily input data through a simple touch action, and first and second parts 112, 114, 212 and 214 dividing touch regions of the first and second touch keys 110 and 210 in order to prevent a touch error. The first touch keys 110 are aligned adjacent to each other along horizontal and vertical directions thereof. In addition, the first touch keys 110 are integrally formed with each other, and the second touch keys 210 are also integrally formed with each other.

In detail, the portable terminal according to the present invention includes a main housing 100, a sliding housing 200 moving lengthwise along the main housing 100 while a lower surface of the sliding housing 200 facing an upper surface of the main housing 100, first touch keys 110 aligned in a predetermined region of an upper surface 100a of the main housing 100, and first parts 112 and 114 for dividing a touch region of the first touch keys 110. Above-mentioned touch keys 110 and 210 refer to data input apparatuses allowing a user to input desired data by a simple touch action. In addition, the first parts 112 can be formed as first protrusions or can be formed as convex sections. In addition, it is not required for the first parts 112 and 114 to be formed such that the touch regions are horizontally or vertically divided by the first parts 112 and 114. That is, the touch regions can be formed in a circular pattern or in a symbol pattern.

The first parts 112 and 114 vertically protrude from the upper surface 100a of the main housing 100, and are continuously formed. In addition, the first touch keys 110 are integrally formed with the first parts 112 and 114.

The sliding housing 200 includes a plurality of second touch keys 210, which are formed on an upper surface of the sliding housing 200 in order to allow a user to input data through a touch action. In addition, second parts 212 and 214 protrude from the upper surface of the sliding housing 200 in order to divide touch regions of the second touch keys 210. The second parts 212 and 214 vertically protrude from the upper surface 200a of the sliding housing 200. In addition, the second touch keys 210 and the second parts 212 and 214 are integrally formed with each other. In addition, the second protrusions 212 and 214 are continuously formed.

Preferably, a protuberance section 216 is formed at a predetermined portion adjacent to the second touch keys 210, that is, at an upper portion of the sliding housing 200 to facilitate sliding movement of the sliding housing 200. The protuberance section 216 includes a plurality of protuberances extending in a direction perpendicular to a sliding direction of the sliding housing 200. The protuberance section 216 is integrally formed with the second touch keys 210.

In addition, the sliding housing 200 is provided on the upper surface 200a thereof with a speaker 204, a liquid crystal display device 206 disposed adjacently to the speaker 204, and the second touch keys 210 disposed adjacently to the liquid crystal display device 206. When the sliding housing 200 is moved into an open position or a closed position with respect to the main housing 100, the first touch keys 110 are opened or closed according to the movement of the sliding housing 200. The second touch keys 210 remain exposed due to their external location. Accordingly, the first touch keys 110 are opened or closed depending on the sliding movement of the sliding housing 200.

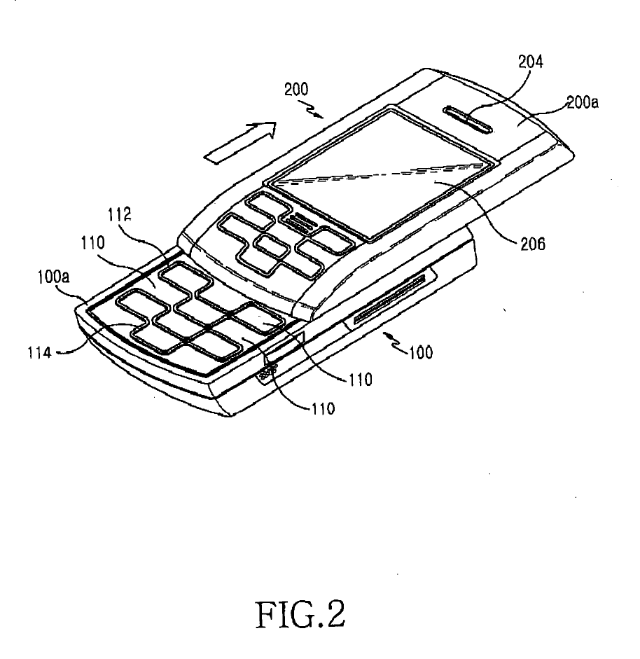

As shown in FIG. 1, when the sliding housing 200 is positioned in a closed position with respect to the main housing 100, the second touch keys 210 overlap the first touch keys 110. As shown in FIG. 2, when the sliding housing 200 is moved into the open position away from the main housing 100, the first touch keys 110 are disposed adjacently to the second touch keys 210.

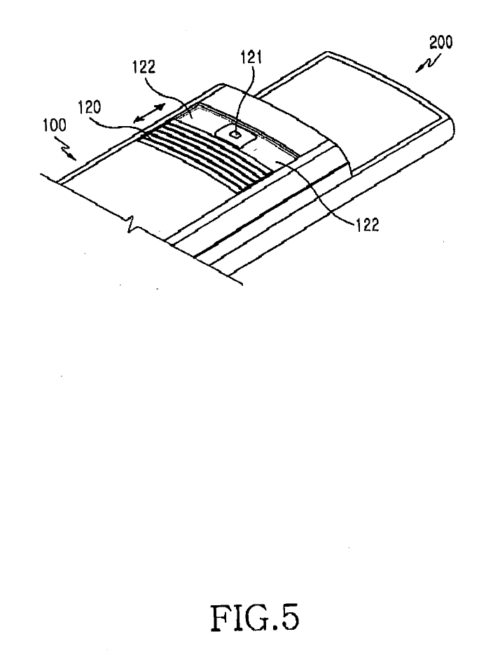

As shown in FIG. 5, the portable terminal according to the present invention is provided on a lower surface thereof with a camera lens 121 and a pair of illumination units 122 disposed adjacently to the camera lens 121. In addition, the camera lens 121 and the illumination units 122 are protected by a sliding cover 120.

As described above, according to the present invention, first and second touch keys are employed in the portable terminal, so an external appearance of the portable terminal becomes simple and cosmetically appealing. In addition, a user can input data by a simple touch action, so a data input action can be conveniently achieved. In addition, a touch error can be prevented by employing protrusions for dividing touch regions. In addition, the protuberance section according to the present invention is provided on a predetermined region of the sliding housing, so the sliding movement of the sliding housing can be easily performed.

While the invention has been shown and described with reference to certain preferred embodiments thereof, it will be understood by those skilled in the art that various changes in form and details may be made therein without departing from the spirit and scope of the invention as defined by the appended claims.

1. A portable terminal comprising:
a main housing;
a sliding housing, which is opened and closed with respect to the main housing;
a plurality of first touch keys aligned on an upper surface of the main housing to allow a user to input data into the portable terminal with a touch action; and
first parts for dividing touch regions of the first touch keys.

2. The portable terminal as claimed in claim 1, wherein the first parts include first protrusions, and the touch area is horizontally divided by the first protrusions.

3. The portable terminal as claimed in claim 1, wherein the first parts include first protrusions, and the touch area is vertically divided by the first protrusions.

4. The portable terminal as claimed in claim 1, wherein the first parts include first protrusions which shape the touch area into a circle.

5. The portable terminal as claimed in claim 1, wherein the first parts include first protrusions which shape the touch area into a symbol.

6. The portable terminal as claimed in claim 1, further comprising a plurality of second touch keys provided on an upper surface of the sliding housing to allow a user to input data by touching the second touch keys.

7. The portable terminal as claimed in claim 6, further comprising second parts being protrusions for dividing touch regions of second touch keys, wherein the second parts vertically protrude from an upper surface of the sliding housing.

8. The portable terminal as claimed in claim 6, further comprising a protuberance section integrally formed with the second touch keys for slidably opening and closing the sliding housing.

9. The portable terminal as claimed in claim 1, wherein the first parts vertically protrude from an upper surface of the main housing.

10. The portable terminal as claimed in claim 1, wherein the first parts are continuously formed.

11. The portable terminal as claimed in claim 7, wherein the second parts are continuously formed.

12. The portable terminal as claimed in claim 6, wherein the first touch keys are opened and closed by the sliding housing, the second touch keys overlap the first touch keys when the sliding housing is positioned in a closed position with respect to the main housing, and the first touch keys are disposed adjacently to the second touch keys when the sliding housing is moved into an open position away from the main housing.

13. The portable terminal as claimed in claim 1, wherein the first touch keys are integrally formed with the first parts.

14. The portable terminal as claimed in claim 7, wherein the second touch keys are integrally formed with the second parts.

15. The portable terminal as claimed in claim 1, further comprising a camera lens embedded on a bottom surface of the main housing for taking photographs and movies.

16. The portable terminal as claimed in claim 15, further comprising at least one illumination unit disposed adjacent to the camera.

17. The portable terminal as claimed in claim 16, further comprising a sliding cover for protecting the camera lens and the at least one illumination unit when not in use.

18. A portable terminal comprising:
a main housing;
a sliding housing, which is slid open and closed with respect to the main housing;
a plurality of first touch keys aligned on an upper surface of the main housing to allow a user to input data into the portable terminal with a touch action;
first parts for dividing touch regions of the first touch keys;
a plurality of second touch keys aligned on an upper surface of the sliding housing to allow a user to input data into the portable terminal with a touch action; and
second parts for dividing touch regions of the second touch keys.
